(19) United States
(12) Patent Application Publication
(10) Pub. No.: US 2015/0281422 A1
(43) Pub. Date: Oct. 1, 2015

(54) Handheld Apparatus For Communicating Control Signals To An Information Processing Device

(71) Applicant: PHONEJOY SOLUTIONS LIMITED, Hong Kong (CN)

(72) Inventors: Martin Kessler, Kowloon (HK); Alexander Moroz, Fortress Hill (HK); Dale C. Schroeder, Brighton, CO (US)

(21) Appl. No.: 14/443,381

(22) PCT Filed: Sep. 13, 2013
(86) PCT No.: PCT/CN2013/083439

§ 371 Date: May 16, 2015

(30) Foreign Application Priority Data
Nov. 23, 2012 (HK) 12112055.3

(51) Int. Cl. H04M 1/725; H04W 4/00; H04M 11/00; G06F 1/16

(52) U.S. Cl. CPC H04M 1/7253; G06F 1/169; H04W 4/008; H04M 11/007; H04M 1/72544

(57) ABSTRACT

Provided is a game pad (10) comprising left and right handle housings (12, 14) adapted to be gripped by a user. The left and right handle housings (12, 14) are interconnected in such a manner as to enable them to be moved apart a sufficient amount to define therebetween a central space (68) for receiving and gripping a handheld information processing device (70) such as a smart phone or the like in a lengthwise orientation. The game pad (10) contains control circuitry (72, 74) and a communications module (80) whereby the game pad (10) can generate control signals and communicate these via a short range wireless protocol to the smart phone (70) in order to exert some control over a game or other application running on the smart phone (70). The arrangement of the left and right handle housings (12, 14) on either side of the centrally defined space (68) provides an ergonomically efficient and balanced apparatus for holding the smart phone (70) in a user friendly orientation and is such that a user can manipulate movement of the smart phone (70) as required where the application running on the smart phone is utilizing motion sensors or the like of the smart phone to create additional control inputs for the application being executed.

### FIELD OF THE INVENTION

The invention relates to a handheld apparatus for communicating control signals to an information processing device and, more particularly, but not exclusively, to a handheld controller apparatus such as a game pad for communicating control signals to a handheld information processing device such as a smart phone attached to the handheld controller apparatus.

### BACKGROUND OF THE INVENTION

Handheld information processing devices such as mobile phones, smart phones, personal digital assistants, e-readers and even tablet computers are increasingly being used for extended functions and applications including playing games of the type heretobefore adapted for playing on dedicated games consoles. Many of these handheld devices and, more particularly, smart phones running operating systems such as Android™ or iOS (IPhone™ operating system) are becoming as powerful from an information processing perspective as dedicated game consoles or even personal computers ‘PCs’. As a result, consumers are increasingly using their smart phones to play sophisticated games rather than use dedicated games consoles. However, there are a number of limitations, both at the physical level and the processing control level, with using current smart phones to play the more advanced games.

In response to these limitations, a number of game pads have been devised that enable a user to play a game on a handheld information processing device such as a smart phone using the game pad to generate some of the control inputs required for playing the game. One such game pad device apparatus comprises a housing containing control circuitry and a communications module. On an upper front edge of the housing is provided a bracket which enables a smart phone to be physically, but releasably attached to the upper front edge of the game pad apparatus. The game pad apparatus communicates with the smart phone through a short range wireless communication protocol such as Bluetooth™. The game pad apparatus executes software to thereby generate control inputs for a game playing on the smart phone and communicates these inputs to the smart phone via a short range wireless communication linked established between the game pad apparatus and the smart phone. By physically attaching the smart phone to the upper front edge of the game pad apparatus, this enables a user to not only view the smart phone's screen, but to physically manipulate the orientation in space of the smart phone whereby motion sensor components or the like of the smart phone can be activated to provide additional control inputs for the game being played.

There are, however, a number of problems associated with this type of game pad apparatus. In the first case, the physical attachment of the smart phone to the upper front edge of the game pad apparatus using a bracket depending outwardly from said upper front edge is not stable with the constant risk that the smart phone may become dislodged. Furthermore, although the bracket for attaching the smart phone to the game pad apparatus can be folded away when not in use, it creates an obstacle by the fact that it projects out from the exterior surface of the apparatus and it creates an eyesore in that it is still visible on the exterior of the apparatus even when folded away. Also, as the housing of the game pad apparatus is of a similar width to that of the smart phone, it does not provide an ergonomically efficient means by which a user can manipulate the combined game pad apparatus and attached smart phone in that it is generally unbalanced and unstable. In the event that the housing of the game pad were made wider to improve its handling, this would render it less portable and more bulky for storing.

### OBJECTS OF THE INVENTION

An object of the invention is to mitigate or obviate to some degree one or more problems associated with known game pad apparatuses of the type adapted to physically mount and to interoperate with handheld information processing devices such as a smart phones or the like.

The above object is met by the combination of features of the main claims; the sub-claims disclose further advantageous embodiments of the invention.

Another object of the invention is to provide a handheld apparatus for communicating control signals to an information processing device which more stably mounts a handheld information processing device.

Another object of the invention is to provide a handheld apparatus for communicating control signals to an information processing device which mounts a handheld information processing device in a more balanced and easily manipulatable manner.

Yet another object of the invention is to provide a handheld controller apparatus for communicating control signals to an information processing device which hides the means for attaching the handheld information processing device to the handheld controller apparatus when such means is not in use.

One skilled in the art will derive from the following description other objects of the invention. Therefore, the foregoing statements of object are not exhaustive and serve merely to illustrate some of the many objects of the present invention.

### SUMMARY OF THE INVENTION

In one aspect, the invention provides a game pad comprising left and right handle housings adapted to be gripped by a user. The left and right handle housings are interconnected in such a manner as to enable them to be moved apart a sufficient amount to define therebetween a central space for receiving and gripping a handheld information processing device such as a smart phone or the like in a lengthwise orientation. The game pad contains control circuitry and a communications module whereby the game pad can generate control signals and communicate these via a short range wireless protocol to the smart phone in order to exert some control on a game or other application running on the smart phone. The arrangement of the left and right handle housings on either side of the centrally defined space provides an ergonomically efficient and balanced apparatus for holding the smart phone in a user friendly orientation and is such that a user can manipulate movement of the smart phone as required where the application running on the smart phone is utilizing motion sensors or the like of the smart phone to create additional control inputs for the application being executed. Furthermore, the means interconnecting the hand housings is arranged such that, when it is not in use and the handle housings are situated in a closed condition, the interconnection means is generally not visible.

In a first main aspect of the invention, there is provided a handheld apparatus for communicating control signals to an information processing device, comprising: a left handle housing and a right handle housing adapted to be gripped by a user's hands. The left handle housing and the right handle housing define therebetween a space for receiving a handheld information processing device. At least one of said left handle housing and said right handle housing comprises a memory storing machine readable instructions. At least one of said left handle housing and said right handle housing comprises a processor to execute said machine readable instructions in order to generate control signals for said handheld information processing device received in the defined space. At least one of said left handle housing and said right handle housing comprises a communication module for communicating control signals generated by the processor to said handheld information processing device received in the defined space.

Preferably, the left handle housing and the right handle housing define therebetween a centrally arranged space between said handle housings for receiving a handheld information processing device.

Accommodating a handheld information processing device in a space defined between opposing end faces of the left and right handle housings of the controller apparatus of the invention provides a controller apparatus that is well balanced and stable and which allows a user to more easily and comfortably manipulate the orientation in space of the handheld information processing device. Also, the screen of the handheld information processing device occupies a more natural viewing position for the user relative to the location of controls provided on the handle housings.

The arrangement is preferably such that the handheld information processing device is received in a lengthwise orientation within the defined space between the handle housings, i.e. the left handle housing and the right handle housing define therebetween a space of sufficient size to receive a handheld information processing device in a lengthwise orientation relative to the handle housings whereby an axis passing through a largest dimension of the handheld information processing device is parallel to an axis passing through the handle housings when the handheld information processing device is received in the space defined between the handle housings.

By spacing apart the handle housings by an amount at least equal to a length of the handheld information processing provides an ergonomically more comfortable means for a user to manipulate the combined handheld apparatus and handheld information processing device.

Preferably, the left handle housing and the right handle housing define therebetween a space whose size can be varied by movement of the housing handles relative to each other in order to receive handheld information processing devices of differing sizes.

This provides the advantage that the controller or handheld apparatus of the present invention can be used with a range of different sized handheld information processing devices such as smart phones. For handheld information processing devices such as some tablet computers which are generally larger than smart phones or the like, it will be understood that the apparatus of the present invention can be scaled up to accommodate a range of sizes of such tablet computers.

Preferably, as is known, the communication module is adapted to communicate control signals to an information processing device using a short range wireless communication protocol such as Bluetooth™ or WiFi™ as this negates the need to provide an electrical connection means on the apparatus of the invention for electrically connect to a handheld information processing device.

In a preferred embodiment, the left handle housing and the right handle housing may be physically interconnected by an extension mechanism. The extension mechanism may be adapted to enable said handle housings to be moved away from each other from a closed position to thereby define the space therebetween for receiving a handheld information processing device.

Preferably, the extension mechanism is arranged such that it enables the handle housings to be placed in very close proximity to one another to define a closed position of the handheld apparatus whereby it is not possible to receive a handheld information processing device in any space existing between said housing handles in said closed position. Preferably, in its closed condition, there is little or no space between opposing end faces of the handle housings, but that said handle housings abut to form a single unit controller apparatus.

In its closed condition, the handheld apparatus of the invention can be used in a more conventional manner as a standalone game controller whereby it is connected by a suitable cable or by a short range wireless communication link to a remote information processing device to thereby communicate control signals to said remote device.

At least one of the handle housings may be adapted to receive therewithin all or part of the extension mechanism when the handheld apparatus is in its closed position whereby the extension mechanism is generally hidden from view when the handheld apparatus is in said closed position.

In a preferred embodiment, each of the handle housings is adapted to receive a respective part of said extension mechanism therewithin when the handheld apparatus is in its closed position to thereby hide the extension mechanism from view.

Preferably, the extension mechanism comprises a telescoping slide mechanism thereby making it easier to accommodate said extension mechanism within the handle housings when the controller apparatus of the invention is in its closed condition.

In a preferred embodiment, the left handle housing and the right handle housing each comprise respective control circuitry and said respective control circuitries are electrically connected by an electrical connection means. The electrical connection means may be arranged to pass through the extension mechanism.

Using the extension mechanism as a form of conduit for the electrical connection means not only provides some protection for said electrical connection, but also saves space.

In a preferred embodiment, the electrical connection means comprises a flexible circuit for enabling the respective control circuitries of the handle housing to communicate with each other. In one embodiment, the flexible circuit comprises a flexible, flat multi-wire electrical connector.

The flexibility of the flexible circuit more easily accommodates the extension and retraction of the extension mechanism.

In a preferred embodiment, the extension mechanism is biased so as to resist movement of the handle housings away from each other. Preferably, the biasing of the extension mechanism is of a sufficient strength as to provide a sufficient gripping force for holding a handheld information processing device between respective opposing end faces of the handle housings which define the space provided by the handheld apparatus for receiving the handheld information processing device.

Conveniently, the biasing of the extension mechanism for causing its retraction also provides the gripping force or a part of the gripping force for holding a handheld information processing device between opposing end faces of the handle housings.

In a preferred embodiment, the extension mechanism comprises a store for the flexible circuit when the handheld apparatus is in its closed position. When the handle housings are moved apart, an appropriate amount of the stored flexible circuit is released under tension of a biasing system to accommodate the moving apart of the left and right handle housings.

Advantageously, by storing the flexible circuit under tension, this allows the extension mechanism to be extended and retracted whilst preventing the flexible circuit becoming snagged within the extension mechanism and yet enables a sufficient amount of the flexible circuit to be released from its stored condition to accommodate an extension of the extension mechanism. Furthermore, the tension exerted on the flexible circuit can advantageously also be used as the sole or part of the biasing system for causing the handle housings to close together towards their closed condition when there is no handheld information processing device placed in the defined space.

The store in the extension mechanism may comprise a guide system comprising a plurality of guides. These may define between them an overlapping path for accommodating the flexible circuit when the handheld apparatus is in its closed position. At least one of the guides may be slidable in a direction of extension of the extension mechanism to thereby release a stored amount of the flexible circuit as the handle housings are being moved apart. More preferably, the guide system includes two slidable guides which slide in opposing directions to each other to thereby release between them an appropriate amount of the stored flexible circuit when the handle housings are being moved apart. Preferably, also, the guide system defines a storage pathway for the flexible circuit which has a plurality of overlapping pathway sections. The guide system may comprise at least five overlapping pathway sections when the extension mechanism is in its closed state.

Using a storage system comprising a plurality of overlapping pathway sections provides an efficient means by which an appropriate amount of the stored flexible circuit can be released from the store or withdrawn back into the store without snagging.

In a preferred embodiment, the telescoping slide mechanism comprises at least a central slide section and respective primary sections within which the central section is accommodated when the slide mechanism is in its closed state. More preferably, the slide mechanism comprises the central section, respective secondary slide sections within which the central slide section is accommodated when the slide mechanism is in a closed state, and the respective primary sections within which the secondary sections are respectively accommodated when the slide mechanism is in its closed state. Preferably, the primary slide sections are accommodated within respective ones of the handle housings when the handheld apparatus is in its closed position.

Preferably, respective biasing means are provided between the handle housings and respective primary sections of the slide mechanism to thereby bias said primary sections to their closed state within the handle housings. Preferably also, the biasing mechanism for placing the flexible circuit under tension is the primary biasing mechanism for causing the sections of the sliding mechanism to close together. Preferably further, the biasing means provided between the handle housings and respective primary sections of the slide mechanism are the primary biasing means for causing the primary sections of the slide mechanism to withdraw within their respective handle housings.

In a preferred embodiment, the biasing means provided between the handle housings and respective primary sections of the slide mechanism and the biasing mechanism for placing the flexible circuit under tension together act as a combined means of biasing the handle housings to their closed position.

In accordance with a second main aspect of the invention, there is provided a combination of a handheld apparatus according to the first main aspect of the invention and a handheld information processing device received in a space defined between the handle housings of the handheld apparatus.

In accordance with a third main aspect of the invention, there is provided a kit of parts for a handheld controller apparatus for communicating control signals to an information processing device, said kit of parts comprising: a left handle housing adapted to be gripped by a user; a right handle housing adapted to be gripped by a user; an interconnection device for at least physically interconnecting said left handle housing and said right handle housing in a spaced apart relationship to define therebetween a space for receiving a handheld information processing device; at least one of said left handle housing and said right handle housing comprising a communication module for communicating control signals to said handheld information processing device received in the defined space.

The interconnection device may be adapted to also electrically connect respective control circuitry provided in said left and right handle housings.

The interconnection device may be adapted to support a handheld information processing device thereupon within the defined space.

In accordance with a fourth main aspect of the invention, there is provided a computer program product comprising a computer readable medium carrying machine readable instructions executable by a processor for controlling a handheld apparatus according to the first main aspect of the invention to generate control signals for a handheld information processing device received in a space defined between the handle housings of the handheld apparatus.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a front perspective view of a handheld controller apparatus according to the invention in a closed state;

FIG. 2 is a front view of the handheld controller apparatus of FIG. 1;

FIG. 3 is a back view of the handheld controller apparatus of FIG. 1;

FIG. 4 is a left side view of the handheld controller apparatus of FIG. 1;

FIG. 5 is a right side view of the handheld controller apparatus of FIG. 1;

FIG. 6 is a top view of the handheld controller apparatus of FIG. 1;

FIG. 7 is a bottom view of the handheld controller apparatus of FIG. 1;

FIG. 8 is a front view of the handheld controller apparatus of FIG. 1 in a first partially opened state;

FIG. 9 is a front view of the handheld controller apparatus of FIG. 1 in a second partially opened state;

FIG. 10 is a front view of the handheld controller apparatus of FIG. 1 in a fully opened state;

FIG. 11 is a front view of the handheld controller apparatus of FIG. 1 in a fully opened state with a handheld information processing device received in a central space between left and right handle housings;

FIG. 12 is a bottom view of the controller apparatus and handheld information processing device combination of FIG. 11;

FIG. 13 is a front perspective view of the extension mechanism for the embodiment of FIG. 1;

FIG. 14 is a front view of the extension mechanism for the embodiment of FIG. 1;

FIG. 15 is a bottom view of the extension mechanism of FIG. 14;

FIG. 16 is a back view of the extension mechanism of FIG. 14;

FIG. 17 is a front perspective view of the extension mechanism for the embodiment of FIG. 1 with the top cover plates removed;

FIG. 18 is an enlarged front view of the extension mechanism of FIG. 17;

FIG. 19 is an enlarged partial schematic top view of the extension mechanism of FIG. 17; and

FIG. 20 is an enlarged partial schematic top view of the central section of the extension mechanism of FIG. 17.

### DESCRIPTION OF PREFERRED EMBODIMENTS

The following description is of a preferred embodiment by way of example only and without limitation to the combination of features necessary for carrying the invention into effect.

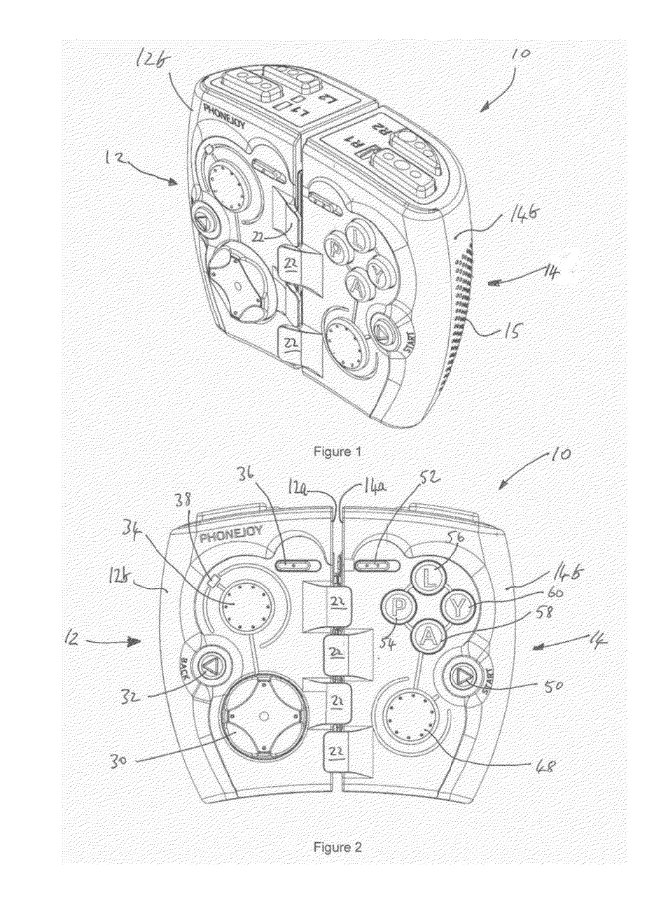

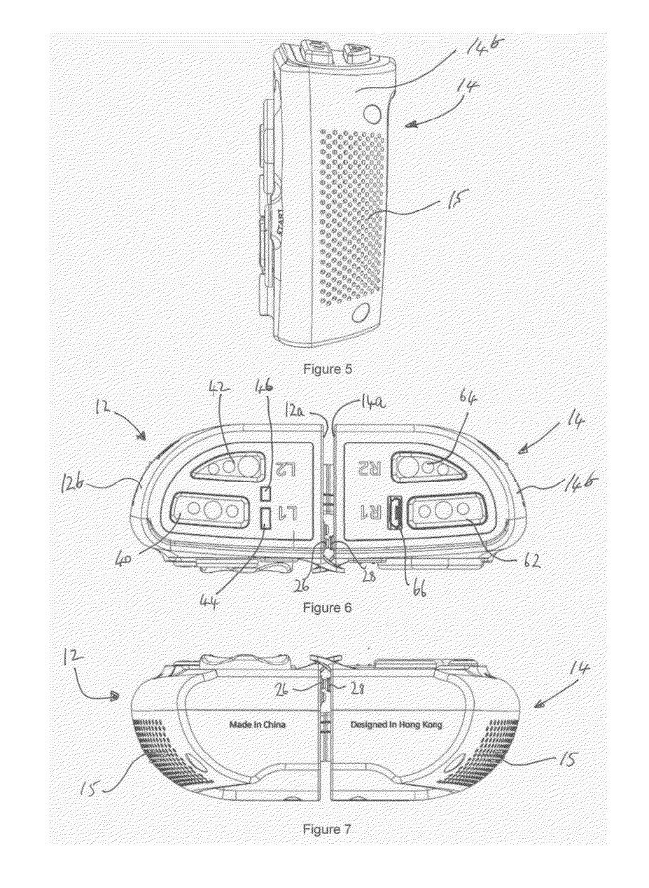

Referring to the drawings, a handheld controller apparatus 10 according to the invention is shown in FIGS. 1 to 7 in what is referred to hereinafter as its closed position, closed condition or closed state whereby a left handle housing 12 is positioned in very close proximity to a right handle housing 14 to thereby form a unitary handheld controller apparatus 10 in this state. As can be seen in the drawings, respective opposing end walls 12a, 14a of the left and right handle housings 12, 14 are in near abutment, although in some embodiments the opposing end walls will be in actual abutment and may also interlock to form the unitary handheld controller apparatus 10 when in the closed condition.

It will be understood that, whilst the handheld controller apparatus 10 is referred to as being in a closed condition with reference to FIGS. 1 to 7, the controller apparatus 10 is operational as a controller apparatus for communicating control signals to a remote information processing device with which it is connected by a suitable wired or wireless communication link such as a Universal Serial Bus ‘USB’ cable for a wired communication link or a short range Bluetooth™ or WiFi™ wireless communication link.

The left handle housing 12 and the right handle housing 14 are sized and shaped so as to be easily gripped by a user when operating the handheld controller apparatus 10. As can be seen in the drawings, an outer edge surface 12b, 14b of each of the left and right handle housings 12, 14 is curved in at least two dimensions to provide respective hand grips that generally conform to the palms of a user's hands. The outer edge surfaces 12b, 14b comprise palm grip surfaces. Each of the palm grip surfaces 12b, 14b may be provided with a pattern 15 of a plurality of small bumps and/or indentations to provide an enhanced grip surface to reduce or prevent slippage of a user's hands when gripping the controller apparatus 10.

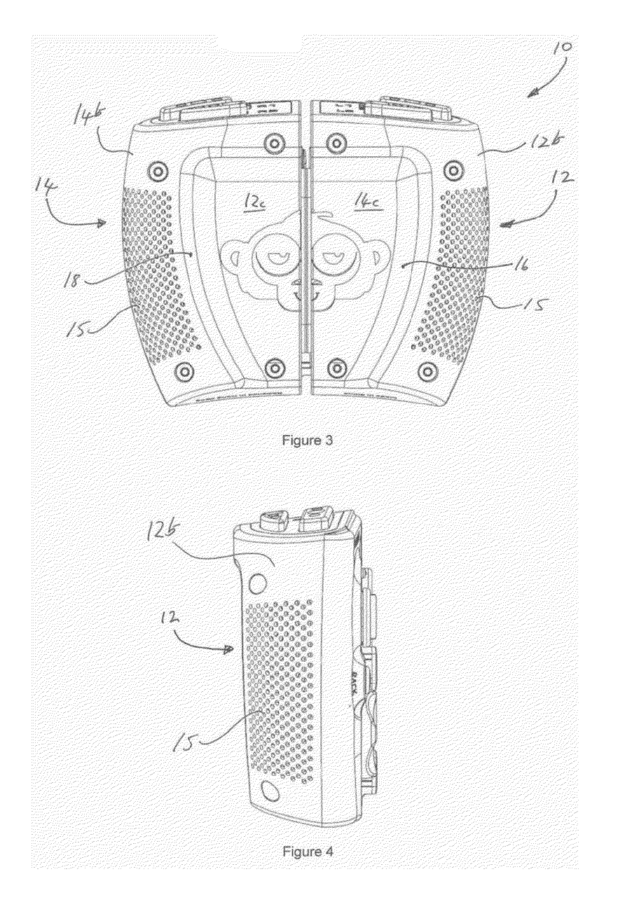

Furthermore, back surfaces 12c, 14c (FIG. 3) of each of said left and right handle housings 12, 14 may be recessed to provide respective finger grip surfaces 16, 18 to enhance a user's grip of the controller apparatus 10 in use. The finger grip surfaces 16, 18 may each comprise an inwardly curved, inwardly facing, preferably sloped wall that is shaped so as to generally conform to an arc or curve defined by a user's fingertips when the user is gripping the controller apparatus 10.

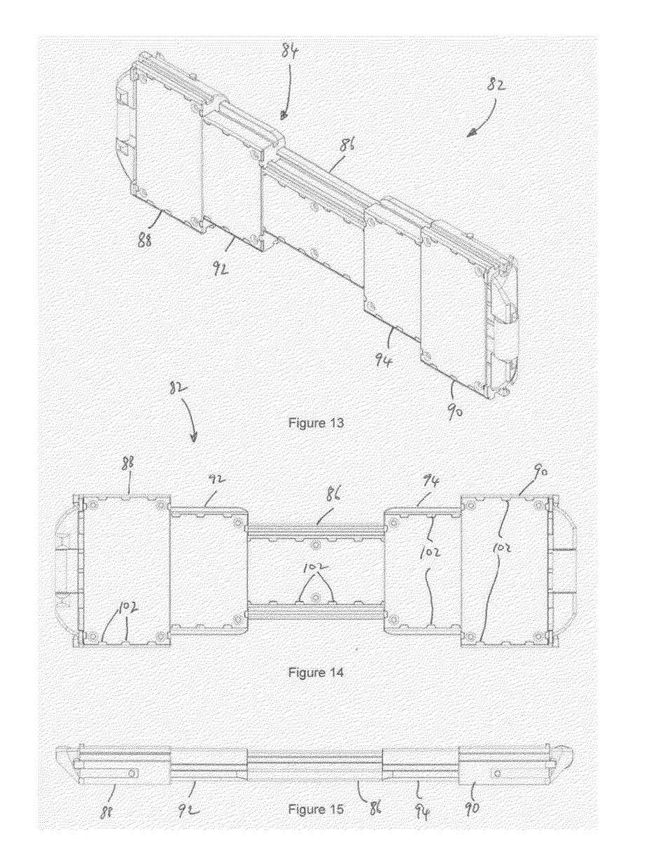

In the preferred embodiment as shown in the drawings, each of the left and right handle housings 12, 14 may be provided with a pair of interlocking tongue members 22, 24 which, when the controller apparatus 10 is in its closed state generally cover the junction between the opposing end faces 12a, 14a of the left and right handle housings 12, 14, but which may, as can be better seen in FIG. 12, act to retain a handheld information processing device in a space defined between the opposing end faces 12a, 14a of the left and right handle housings 12, 14 when the controller apparatus 10 is in an open state as will be explained in greater detail below.

In the preferred embodiment as shown in the drawings, each of the left and right handle housings 12, 14 may also be provided with at least one gripping stud 26, 28 (FIGS. 6 and 7) which abut each other when the controller apparatus 10 is in its closed state, but which may assist retention of a handheld information processing device in a space defined between the opposing end faces 12a, 14a of the left and right handle housings 12, 14 when the controller apparatus 10 is in an open state.

In the preferred embodiment as shown in the drawings, each of the left and right handle housings 12, 14 is provided with a number of user input means. The user input means may comprise any one or a combination of a direction pad ‘D pad’, a joy stick, and one or more push buttons. However, it will be understood that in some embodiments user input means may be provided on only one of the handle housings.

In the preferred embodiment shown in the drawings, the left handle housing 12 is provided with a D pad 30, a ‘BACK’ push button 32, an analog joy stick 34, a power on/off switch 36, a power on/off LED 38, first and second ‘LEFT’ push buttons 40, 42, a charging LED 44 and an analog on/off LED 46. The right handle housing 14 is provided with an analog joy stick 48, a ‘START’ push button 50, an analog on/off switch 52, four action pushbuttons ‘P’ 54, ‘L’ 56, ‘A’ 58 and ‘Y’ 60, first and second ‘RIGHT’ push buttons 62, 64 and a micro-USB charging port 66.

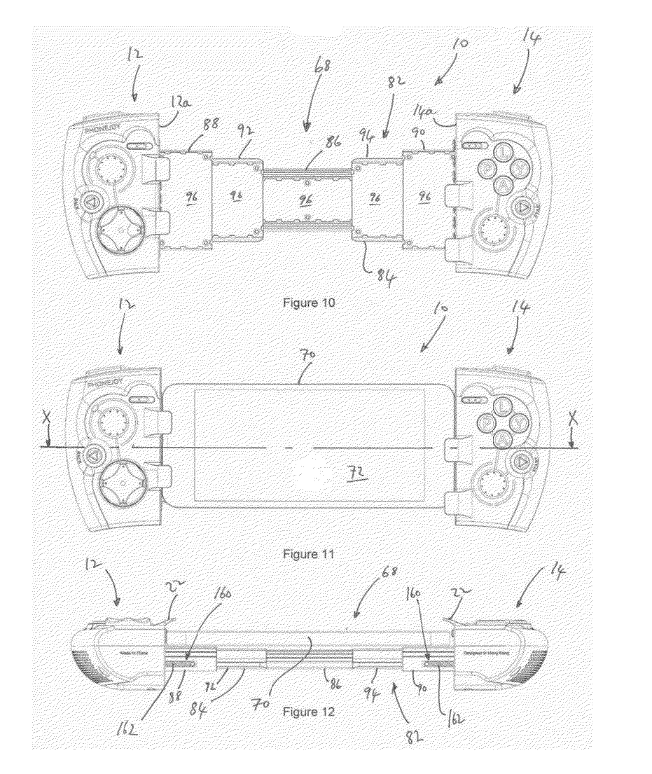

In an open state of the controller apparatus 10 of the invention and as best seen in FIGS. 10 to 12, the left handle housing 12 and the right handle housing 14 can be placed apart by a sufficient amount to define therebetween a central space 68 for receiving a handheld information processing device 70.

Accommodating a handheld information processing device 70 in a space 68 defined between the opposing end faces 12a, 14a of the left and right handle housings 12, 14 of the controller apparatus 10 of the invention provides a controller apparatus 10 that is well balanced and stable and which allows a user to more easily and comfortably manipulate the orientation in space of the handheld information processing device 70. Also, a screen 72 of the handheld information processing device 70 occupies a more natural viewing position for the user relative to the location of the various user input means provided on the handle housings 12, 14.

The arrangement is preferably such that the handheld information processing device 70 is received in a lengthwise or landscape orientation within the defined space 68 such that an axis X-X (FIG. 11) passing through a largest dimension of the handheld information processing device 70 is parallel to an axis, also X-X, passing through the handle housings 12, 14 when the controller apparatus 10 is in its open state. It will be appreciated, however, that the handheld information processing device 70 may be accommodated in the defined space 68 in a portrait or widewise orientation to facilitate running applications, playing of games or the like on the information processing device 70 which only execute in a portrait mode.

By spacing apart the handle housings 12, 14 by an amount at least equal to a length of the handheld information processing device 70 provides an ergonomically more comfortable means for a user to manipulate the combined handheld controller apparatus 10 and handheld information processing device 70.

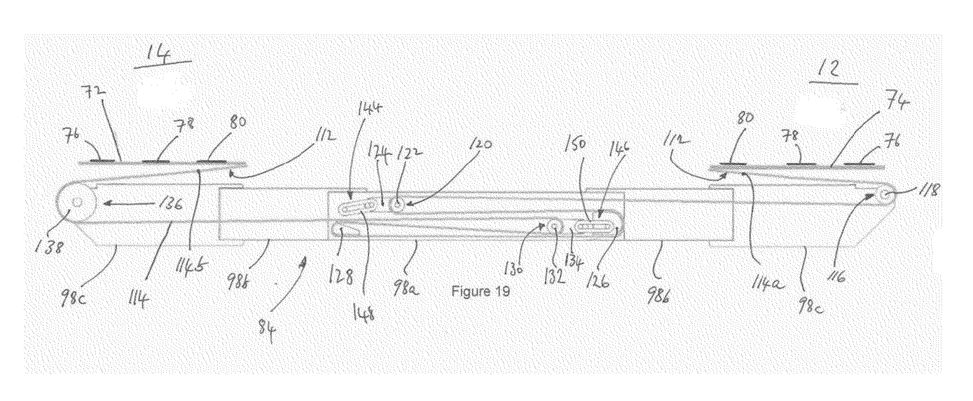

Each of the handle housings 12, 14 is provided with respective control circuitry 72, 74 (FIG. 19), the circuitries 72, 74 being contained within their respective handle housings 12, 14 and preferably comprising suitable components mounted on a circuit board. Each of said circuitries 72, 74 comprises a memory 76 storing machine readable instructions, a processor 78 for executing said machine readable instructions in order to generate control signals for said handheld information processing device 70 received in the defined space 68, and a communication module 80 for communicating any control signals generated by the processor 78 to said handheld information processing device 70. It will be understood that in some embodiments only one of the left and right handle housings 12, 14 will be provided with control circuitry or that said control circuitry may be distributed between said two handle housings 12, 14. However, in the preferred embodiment of the invention, each of the handle housings 12, 14 is provided with respective control circuitry 72, 74 to respectively process user control and/or other inputs entered by a user at such handle housings 12, 14 in order to generate control signals to be communicated to the handheld information processing device 70 received in the defined space 68.

The communication modules 80 are adapted to communicate control and/or other signals to the information processing device 70 using a short range wireless communication protocol such as Bluetooth™ or WiFi™ as this negates the need to provide an electrical or electronic connection means on the controller apparatus 10 of the invention for electrically connecting said apparatus 10 to the information processing device 70. Furthermore, it allows the apparatus 10 to be used with any information processing device that is adapted for short range wireless communication and has a compatible operating system to that of the controller apparatus 10.

In the preferred embodiment as depicted in the drawings, the space 68 between the left handle housing 12 and the right handle housing 14 can be varied by movement of the handle housings 12, 14 relative to each other in order to receive handheld information processing devices 70 of differing sizes.

This provides the advantage that the controller or handheld apparatus 10 of the invention can be used with a range of different sized handheld information processing devices such as smart phones. For handheld information processing devices such as some tablet computers which are generally larger than smart phones or the like, it will be understood that the apparatus 10 may be scaled up to accommodate a range of sizes of such tablet computers.

In order to facilitate the variable spacing apart of the left and right handle housings 12, 14, the handle housings 12, 14 are physically interconnected by an extension mechanism 82. The extension mechanism 82 enables the handle housings 12, 14 to be placed in very close proximity to one another to define the closed position of the handheld controller apparatus 10 (FIGS. 1 to 7) whereby it is not possible to receive a handheld information processing device 70 in any space existing between said housing handles 12, 14 in said closed position.

Each of the handle housings 12, 14 is adapted to receive a respective part of said extension mechanism 82 therewithin when the handheld apparatus is in its closed position to thereby generally hide the extension mechanism from view.

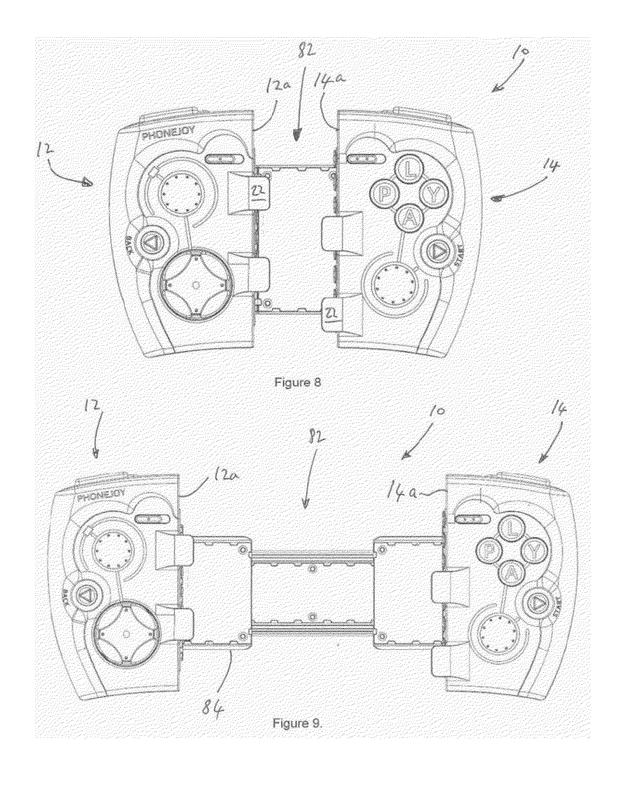

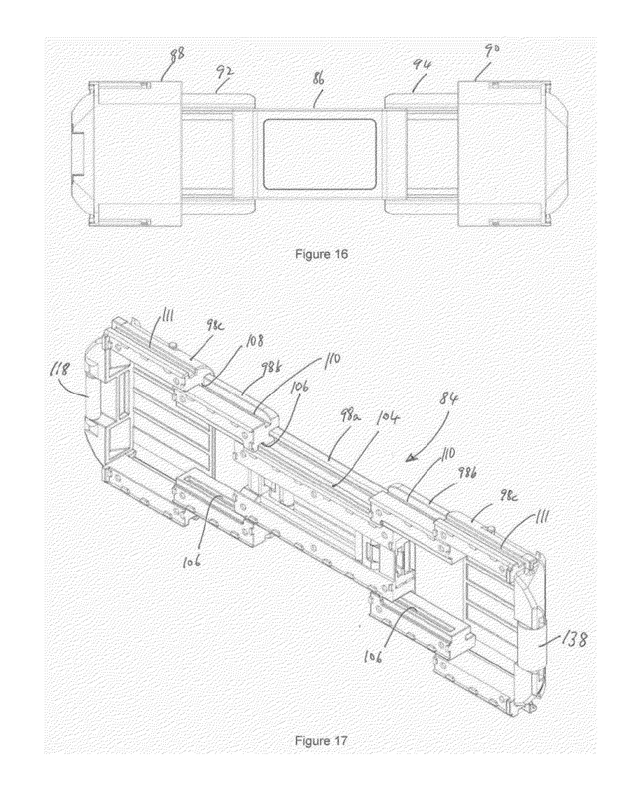

Referring to FIGS. 8 through to 20 and more particularly to FIGS. 13 to 18, it can be seen that the extension mechanism 82 comprises a telescoping slide mechanism 84. This arrangement of the extension mechanism 82 makes it possible to overcome the technical difficulty of providing an extension mechanism 82 that can extend by a distance sufficient to receive a smart phone 70 or the like in a lengthwise orientation whilst enabling the extension mechanism 82 to be accommodated and hidden from general view within the handle housings 12, 14 when the controller apparatus 10 is in its closed condition.

The telescoping slide mechanism 84 comprises a central slide section 86 and respective primary slide sections 88, 90 within which the central section 86 is accommodated when the slide mechanism 84 is in its closed state. However, to better provide a means to move the left and right handle housings 12, 14 apart by a distance sufficient to receive a handheld information processing device 70 in a lengthwise orientation within the defined space 68, the slide mechanism 84 preferably includes in addition to the central slide section 86, respective secondary slide sections 92, 94 within which the central slide section 86 is accommodated when the slide mechanism 84 is in a closed state, and the respective primary sections 88, 90 within which the secondary sections 92, 94 are respectively accommodated when the slide mechanism 84 is in its closed state. The primary slide sections 88, 90 are arranged to be accommodated within respective ones of the handle housings 12, 14 when the handheld controller apparatus 10 is in its closed position.

FIG. 8 shows the controller apparatus 10 with the left and right handle housings 12, 14 in a partially opened state where the slide mechanism 84 is only partially extended. In contrast, FIG. 9 shows the slide mechanism 84 in a half-opened state whilst FIG. 10 shows the slide mechanism 84 in a fully opened condition. It will be appreciated that, when the slide mechanism 84 is extended to its fully opened state (FIG. 10), this defines a maximum space between the opposing end faces 12a, 14a of the handle housings 12, 14 and thus a maximum length of a handheld information processing device 70 that can be received in the defined space 68. It will also be appreciated that the slide mechanism 84 can be extended to define a space 68 of smaller size than that of its fully opened state to receive a handheld information processing device 70 of a smaller than maximum length.

The slide mechanism 84 can be best seen in FIGS. 13 to 18 with FIGS. 13 to 15 depicting the complete sliding mechanism 84 including cover plates 96, whereas FIGS. 16 to 18 show the sliding mechanism 84 with its cover plates 96 removed.

Each section of the slide mechanism 84 comprises a section of generally rectangular cross-section which greatly enhances the strength and rigidity of the mechanism 84. Each section comprises a slide member 98 of moulded plastics construction and a sheet metal cover plate 96. In the preferred embodiment, the sheet metal is sheet steel as this has high strength and is relatively inexpensive. For each section of the slide mechanism 84, the moulded plastics slide member 98 has at least one integrally moulded buttress member 100, but preferably a series of buttress members 100 on opposite side edges to form castellated side edges. Each of the steel sheet metal cover plates 96 has complementary recesses 102 in two of its opposing side edges such that, when a cover plate 96 is placed over its respective slide member 98, the recesses 102 in the castellated side edges of the cover plate 96 mate with the buttresses 100 in the castellated side edges of the slide member 98 to thereby form a precision fit. This arrangement of sheet steel cover plates 96 and moulded plastics material slide members 98 achieves a slide mechanism with a high tolerance fit which greatly enhances the durability of the slide mechanism and greatly enhances its slidability.

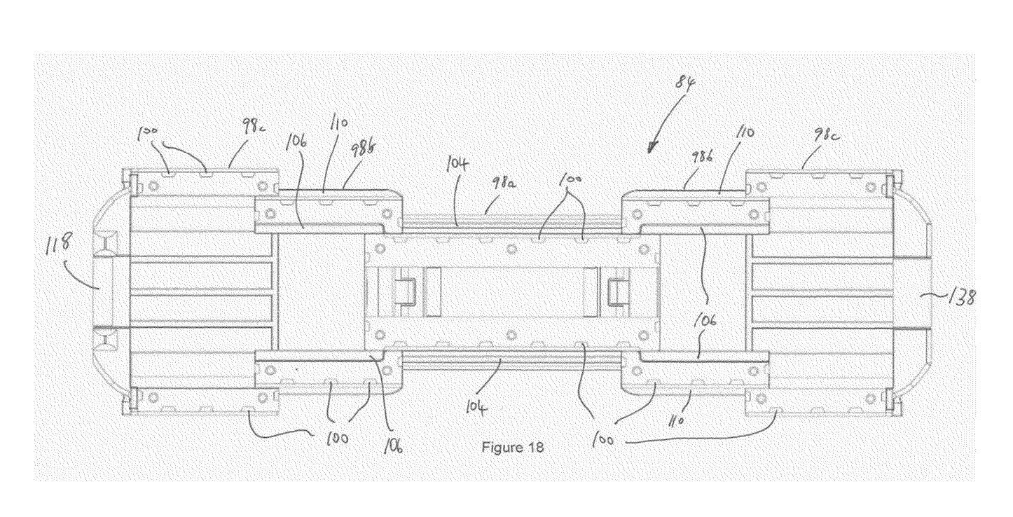

As can be better seen in FIGS. 17 and 18, the central slide member 98a has a pair of integrally moulded elongate tongue members 104 on its outward facing walls such that said tongue members 104 partially locate within respective complementary grooves 106 provided on inner walls of the secondary slide members 98b. The tongue and groove connection between the central slide member 98a and the two secondary slide members 98b allows the central slide member 98a to be wholly slidably accommodated within the two secondary slide members 98b. A similar tongue and groove connection is provided between the two secondary slide members 98b and their respective primary slide members 98c whereby tongue members 108 are provided on inner facing walls of the primary slide members 98c and complementary grooves 110 are provided in outer facing walls of the secondary slide members 98b. The tongue and groove connection between the two secondary slide members 98b and their respective primary slide members 98c allows each secondary slide member 98b to be wholly accommodated within its respective primary slide member 98c.

In like manner, each of the primary slide members 98c forms a tongue and groove connection with its respective one of the handle housings 12, 14. As can be seen in FIG. 17, each of the primary slide members 98c has elongate groves 111 formed in its outermost facing walls which, in use, engage complementary tongue structures formed within the respective handle housings 12, 14 such that the slide mechanism can be substantially or wholly accommodated within the two handle housings 12, 14 as depicted in FIGS. 1 to 7.

The respective control circuitries 72, 74 of the handle housings 12, 14 are electrically connected by an electrical connection means 112. The electrical connection means 112 is preferably arranged to pass through the interior of the extension mechanism 82.

Using the extension mechanism 82 as a form of conduit for the electrical connection means 112 not only provides some protection for said electrical connection means 112, but also saves space. In the preferred embodiment as shown in the drawings, the electrical connection means 112 comprises a flexible circuit 114 for enabling the respective control circuitries 72, 74 of the handle housings 12, 14 to communicate with each other and for power to be passed from a power supply provided in one of the handle housings to the circuitry provided in the other handle housing. The flexible circuit 114 may comprise a flexible circuit board, a flat multi-wire electrical connector or any suitable electrical power and signal connection means.

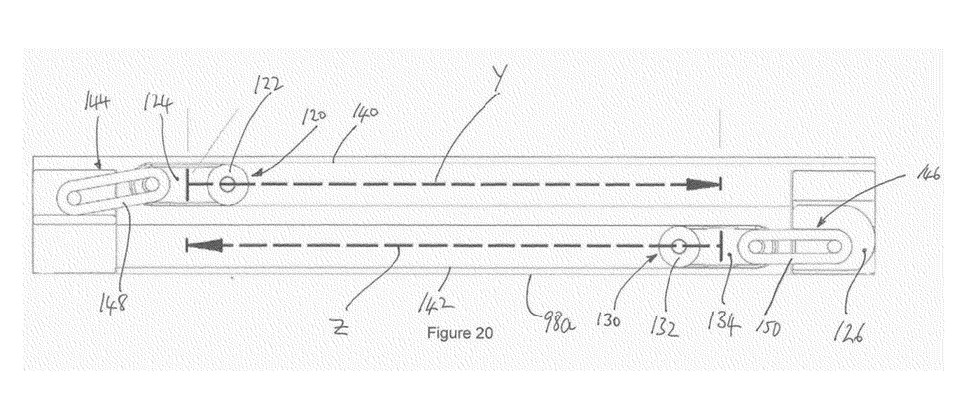

As is best illustrated by FIG. 19, the flexible circuit 114 extends between the respective circuitries 72, 74 of the handle housings 12, 14 passing through an interior of the slide mechanism 84. The flexible circuit 114 is electrically and physically connected at a first end 114a to the circuitry 72 in the left handle housing 12, passes out of said housing 12 by passing around a first guide member 116 in the form of a roller 118 rotatably mounted on the primary slide member 98c of the slide mechanism 84 nearest said left handle housing 12, passes in a first direction through an interior space of a first one of the secondary slide members 98b to then pass into an interior space of the central slide member 98a prior to passing around a second guide member 120 in the form of a roller 122 rotatably mounted on a pair of first sliding members 124 provided in said central slide member 98a, passes in an opposing second direction still within the interior space of the central slide member 98a to then pass around a third guide member 126 before extending again in the first direction to encounter a fourth guide member 128, passing around the fourth guide member 128 to extend again in the second direction and then pass around a fifth guide member 130 in the form of a roller 132 rotatably mounted on a pair of second sliding members 134 to then extend in the first direction, then passing out of the interior space of the central slide member 98a through an interior space of the other secondary slide member 98b and into an interior space of the other primary slide member 98a prior to passing around a sixth guide member 136 in the form of a roller 138 rotatably mounted to said other primary slide member 98a and then connecting electrically and physically at its second end 114b to the circuitry 74 provided in the right handle housing 14. The first and second pairs of sliding members 124, 134 are mounted within the central slide member 98a such that they each can move in a direction of extension of the sliding mechanism 84, but in opposing directions to each other as is best seen in FIG. 20 and denoted by arrowed lines Y and Z. Each pair of sliding members 124, 134 is supported in a pair of respective slots 140, 142 provided within the central slide member 98a of the sliding mechanism. Each pair of sliding members 124, 134 is biased to a stored state by a respective biasing means 144, 146 which, in the preferred embodiment, take the form of elastic silicon or rubber bands 148, 150, although any suitable biasing means could be employed. Consequently, as the handle housings 12, 14 are moved apart, tension is exerted on the flexible circuit 114 causing said first and second pairs of sliding members 124, 134 to move away from their stored positions to thereby release a controlled or appropriate amount of flexible circuit 114 to accommodate the amount of separation of the handle housings 12, 14. The handheld controller apparatus 10 of the invention thereby provides a store for the flexible circuit 114 when the handheld apparatus 10 is in its closed position, this store comprising an overlapping pathway traced by the flexible circuit 114 around the plurality of guide members of the sliding mechanism 84 between the respective circuitries 72, 74 of the left and right handle housings 12, 14. When the handle housings 12, 14 are moved apart, an appropriate amount of the stored flexible circuit 114 is released under tension of the biasing system comprising the biasing means 144, 146 provided to accommodate the moving apart of the left and right handle housings 12, 14.

Advantageously, by storing the flexible circuit 114 under tension, this allows the sliding mechanism 84 to be manually extended and automatically retracted whilst preventing the flexible circuit 114 becoming snagged within the sliding mechanism 84 and yet enables a sufficient amount of the flexible circuit 114 to be released from its stored condition to accommodate an extension of the sliding mechanism 84. Furthermore, the tension exerted on the flexible circuit 114 can advantageously also be used as the sole biasing force or part of the biasing force for causing the handle housings 12, 14 to automatically close together towards their closed condition when there is no handheld information processing device 70 placed in the defined space 68.

As has been described, the store in the sliding mechanism 84 comprises a guide system comprising first to sixth guide members, although any suitable number of guide members could be used. Furthermore, all of the guide mebers could comprise rotatably mounted rollers, although in the preferred embodiment as shown in the drawings, some of the guide members are static guides having smooth surfaces to ensure sliding of the flexible circuit 114 thereover when the flexible circuit 114 is being withdrawn from its stored condition or automatically returned to its stored state. The guide members define between them an overlapping pathway for accommodating the flexible circuit 114 when the handheld apparatus is in its closed position. The storage pathway so defined has a plurality of overlapping pathway sections and, in the preferred embodiment, has five overlapping pathway sections when the extension mechanism is in its closed state.

Using a storage system comprising a plurality of overlapping pathway sections provides an efficient means by which an appropriate amount of the stored flexible circuit 114 can be released from the store or withdrawn back into the store without snagging.

In addition to the biasing system provided in the sliding mechanism 84 for tensioning the flexible circuit 114, there are provided respective pairs of biasing means 160 (FIG. 12) in the form of coil springs 162 attached between the handle housings 12, 14 and respective ones of the primary sections 88, 90 of the slide mechanism 84 to thereby bias said primary sections 88, 90 to their closed state within the handle housings 12, 14. As can be seen in FIG. 12, springs 162 are provided on each side of the handle housings 12, 14. Each spring 162 is arranged such that is attached between a respective handle housing and a respective one of the primary sections of the sliding mechanism. As such, the springs' primary function is to bias the primary sections of the sliding mechanism to their closed positions within their respective handle housings.

The biasing mechanism or system 144, 146 for placing the flexible circuit 114 under tension is preferably the primary biasing mechanism for causing the sections of the sliding mechanism to automatically close together. The biasing means 160 provided between the handle housings and respective primary sections of the slide mechanism are the primary biasing means for causing the primary sections of the slide mechanism to automatically withdraw within their respective handle housings. Consequently, the biasing means 160 provided between the handle housings and respective primary sections of the slide mechanism and the biasing mechanism or system 144, 146 for placing the flexible circuit under tension together act as a combined means of automatically biasing the handle housings to their closed position.

In a preferred embodiment, the extension mechanism 82 is biased so as to resist movement of the handle housings 12, 14 away from each other and is of a sufficient strength so as to provide a sufficient gripping force for holding a handheld information processing device 70 between respective opposing end faces 12a, 14a of the handle housings 12, 14.

In general, the present invention provides a game pad apparatus 10 comprising left and right handle housings 12, 14 adapted to be gripped by a user. The left and right handle housings 12, 14 are interconnected in such a manner as to enable them to be moved apart a sufficient amount to define therebetween a central space 68 for receiving and gripping a handheld information processing device 70 such as a smart phone or the like in a lengthwise orientation. The game pad apparatus 10 contains control circuitry and a communications module whereby the game pad apparatus 10 can generate control signals and communicate these via a short range wireless protocol to the smart phone 70 in order to exert some control on a game or other application running on the smart phone 70. The arrangement of the left and right handle housings 12, 14 on either side of the centrally defined space 68 provides an ergonomically efficient and balanced apparatus for holding the smart phone 70 in a user friendly orientation and is such that a user can manipulate movement of the smart phone 70 as required where the application running on the smart phone 70 is utilizing motion sensors or the like of the smart phone 70 to create additional control inputs for the application being executed.

In another aspect, the invention provides a combined controller apparatus comprising the handheld controller apparatus 10 according to the present invention and a handheld information processing device 70 received in the space 68 defined between the handle housings 12, 14.

In another aspect, the invention provides a kit of parts for a handheld controller apparatus 10 of the invention. The kit of parts comprises the left handle housing 12, the right handle housing 14, an interconnection device for at least physically interconnecting the left handle housing 12 and the right handle housing 14 in a spaced apart relationship to define therebetween the space 68 for receiving a handheld information processing device 70, wherein at least one of said left handle housing 12 and said right handle housing 14 comprises a communication module for communicating control signals to said handheld information processing device 70 received in the defined space 68.

The interconnection device may be adapted to also electrically connect respective control circuitry provided in said left and right handle housings.

The interconnection device may be adapted to support a handheld information processing device thereupon within the defined space.

In another aspect, the invention provides a computer program product comprising a computer readable medium carrying machine readable instructions executable by a processor for controlling the handheld controller apparatus 10 of the invention to generate control signals for a handheld information processing device 70 received in the space 68 defined between the handle housings 12, 14 of the handheld controller apparatus 10.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A handheld apparatus for communicating control signals to an information processing device, comprising:
a left handle housing and a right handle housing adapted to be gripped by a user's hands, said left handle housing and said right handle housing defining therebetween a space for receiving a handheld information processing device;
at least one of said left handle housing and said right handle housing comprising a memory storing machine readable instructions;
at least one of said left handle housing and said right handle housing comprising a processor to execute said machine readable instructions in order to generate control signals for said handheld information processing device received in the defined space; and
at least one of said left handle housing and said right handle housing comprising a communication module for communicating control signals generated by the processor to said handheld information processing device received in the defined space,
wherein the left handle housing and the right handle housing each comprise respective control circuitry and said respective control circuitries are electrically connected by a flexible circuit; and
wherein the handheld apparatus comprises a store for the flexible circuit when the handheld apparatus is in a closed position, the arrangement being such that, when the handle housings are moved apart, an amount of the stored flexible circuit is released under tension of a biasing system.

2. The handheld apparatus of claim 1, wherein the left handle housing and the right handle housing define therebetween a space whose size can be varied by movement of the housing handles relative to each other in order to receive handheld information processing devices of differing sizes.

3. The handheld apparatus of claim 1, wherein the handheld apparatus comprises a game pad apparatus for controlling a game application running on an information processing device of a type having a touch screen as one of its primary means for receiving user input to said handheld information processing device.

4. The handheld apparatus of claim 1, wherein the communication module is adapted to communicate control signals to an information processing device using a short range wireless communication protocol.

5. The handheld apparatus of claim 1, wherein the left handle housing and the right handle housing are physically interconnected by an extension mechanism which is adapted to enable said handle housings to be moved away from each other from said closed position to thereby define the space therebetween for receiving a handheld information processing device.

6. The handheld apparatus of claim 5, wherein each of the handle housings is adapted to receive a respective part of said extension mechanism therewithin when the handheld apparatus is in said closed position to thereby hide the extension mechanism from view.

7. The handheld apparatus of claim 5, wherein the flexible circuit passes through the extension mechanism.

8. The handheld apparatus of claim 7, wherein the flexible circuit enables the respective control circuitries of the handle housings to communicate with each other.

9. The handheld apparatus of claim 5, wherein the extension mechanism is biased so as to resist movement of the handle housings away from each other and wherein the biasing is of a sufficient strength as to provide a sufficient gripping force for holding a handheld information processing device between respective opposing end faces of the handle housings which define the space for receiving the handheld information processing device.

10. The handheld apparatus of claim 8, wherein the extension mechanism comprises the store for the flexible circuit when the handheld apparatus is in its closed position.

11. The handheld apparatus of claim 10, wherein the store in the extension mechanism comprises a guide system comprising a plurality of guides which between them define an overlapping path for accommodating the flexible circuit when the handheld apparatus is in its closed position and wherein at least one of the guides is slidable in a direction of extension of the extension mechanism to thereby release a stored amount of the flexible circuit as the handle housings are being moved apart.

12. The handheld apparatus of claim 10, wherein the extension mechanism comprises a telescoping slide mechanism which comprises a central slide section, respective secondary slide sections within which the central slide section is accommodated when the slide mechanism is in a closed state, and respective primary sections within which the secondary sections are respectively accommodated when the slide mechanism is in its closed state.

13. The handheld apparatus of claim 12, wherein respective biasing means are provided between the handle housings and respective primary sections of the slide mechanism and wherein the biasing means provided between the handle housings and respective primary sections of the slide mechanism and the biasing mechanism for placing the flexible circuit under tension together act as a combined means of biasing the handle housings to their closed position.

14. (canceled)

15. A kit of parts for a handheld controller apparatus for communicating control signals to an information processing device, said kit of parts comprising:
a left handle housing adapted to be gripped by a user;
a right handle housing adapted to be gripped by a user;
an interconnection device for at least physically interconnecting said left handle housing and said right handle housing in a spaced apart relationship to define therebetween a space for receiving a handheld information processing device;
at least one of said left handle housing and said right handle housing comprising a communication module for communicating control signals to said handheld information processing device received in the defined space,
wherein the left handle housing and the right handle housing each comprise respective control circuitry and said respective control circuitries are electrically connected by a flexible circuit; and
wherein the handheld apparatus comprises a store for the flexible circuit when the handheld apparatus is in a closed position, the arrangement being such that, when the handle housings are moved apart, an amount of the stored flexible circuit is released under tension of a biasing system.

16. A computer program product comprising a computer readable medium carrying machine readable instructions executable by a processor for controlling a handheld apparatus to generate control signals for a handheld information processing device received in a space defined between the handle housings of the handheld apparatus, said handheld apparatus comprising:
a left handle housing and a right handle housing adapted to be gripped by a user's hands, said left handle housing and said right handle housing defining therebetween a space for receiving a handheld information processing device;
at least one of said left handle housing and said right handle housing comprising a memory storing machine readable instructions;
at least one of said left handle housing and said right handle housing comprising a processor to execute said machine readable instructions in order to generate control signals for said handheld information processing device received in the defined space; and
at least one of said left handle housing and said right handle housing comprising a communication module for communicating control signals generated by the processor to said handheld information processing device received in the defined space,
wherein the left handle housing and the right handle housing each comprise respective control circuitry and said respective control circuitries are electrically connected by a flexible circuit; and
wherein the handheld apparatus comprises a store for the flexible circuit when the handheld apparatus is in a closed position, the arrangement being such that, when the handle housings are moved apart, an amount of the stored flexible circuit is released under tension of a biasing system.
